(19) United States
(12) Patent Application Publication
(10) Pub. No.: US 2017/0128981 A1
(43) Pub. Date: May 11, 2017

(54) BULK METALLIC GLASS COMPONENTS

(71) Applicant: Delavan Inc, West Des Moines, IA (US)

(72) Inventors: Paul Sheedy, Bolton, CT (US); Sonia Tulyani, Glastonbury, CT (US); Neal Magdefrau, Tolland, CT (US)

(73) Assignee: DELAVAN INC, West Des Moines, IA (US)

(21) Appl. No.: 14/936,124

(22) Filed: Nov. 9, 2015

(51) Int. Cl. B05D 5/00; B22D 25/06; C23C 30/00; C23C 24/06; C23C 24/08; B05D 5/08; C23C 4/08; C23C 24/04

(52) U.S. Cl. CPC B05D 5/00; C23C 4/08; B22D 25/06; C23C 24/04; C23C 24/06; C23C 24/087; B05D 5/08; C23C 30/00; C22C 45/00

(57) ABSTRACT

A method of forming a bulk metallic glass (BMG) cladding includes bringing a BMG material to a temperature lower than or equal to the crystallization temperature of the BMG material, and at least in some embodiments greater than or equal to the glass transition temperature of the BMG material and. The method also includes depositing the BMG material onto a substrate with interlock surface features such that the BMG material interlocks with the interlock surface features of the substrate.

### BACKGROUND OF THE INVENTION

1. Field of the Invention

The present disclosure relates to cladding, and more particularly to cladding with metallic glass layers.

2. Description of Related Art

Bulk Metallic Glasses (BMG's) are an emerging class of engineering material that can be made stronger than steel, have corrosion resistance, and can have extremely high elastic limits. One limitation that has limited the applications in which BMG's can be used is that known processing constraints have limited at least one dimension of a given BMG component to less than about 30-40 mm (1.2-1.5 inches). Conversely, for components with one at least one dimension less than about 1-2 mm (0.04-0.08 inches), BMG's offer a unique processability in that they can be thermoplastically formed, similar to plastics.

While such methods have generally been acceptable for their intended applications, there is still a need in the art for improved BMG components. The present disclosure provides a solution for this need.

### SUMMARY OF THE INVENTION

A method of forming a bulk metallic glass (BMG) cladding includes bringing a BMG material to a temperature lower than or equal to the crystallization temperature (Tₓ) of the BMG material, and at least in some embodiments greater than or equal to the glass transition temperature (T_{g}) of the BMG material. The method also includes depositing the BMG material onto a substrate with interlock surface features such that the BMG material interlocks with the interlock surface features of the substrate.

The method can include forming the interlock surface features on a surface of the substrate. Forming the interlock surface features can include forming interlock surface features with receptacles for BMG material that narrow in a direction going deeper within the substrate. The interlock surface features with receptacles for BMG material can form a repeating pattern of substantially identical triangular receptacles, an alternating pattern of two sets of different triangular receptacles, or any other suitable pattern. Forming the interlock surface features can include forming interlock surface features with receptacles for BMG material that form a repeating pattern of substantially identical truncated triangular receptacles with truncated triangular teeth separating each respective adjacent pair of the receptacles. It is also contemplated that forming the interlock surface features can include forming interlock surface features with receptacles for BMG material that widen in a direction going deeper within the substrate, or wherein the receptacles have a uniform dimension in a direction going deeper within the substrate.

Depositing the BMG material can include any suitable process such as at least one of thermoplastic forming, rolling, compression molding, hot pressing, autoclaving, thermal spraying, or cold spraying the BMG material onto the substrate such that the BMG material interlocks with the interlocking surface features of the substrate with the BMG material. Depositing the BMG material can be done with the BMG material at a temperature lower than or equal to the crystallization temperature of the BMG material, at in at least some embodiments greater than or equal to the glass transition temperature of the BMG material. For example, the BMG material can be placed in contact with the substrate with the BMG at room temperature and then the BMG can be heated up to the glass transition temperature (T_{g}) in order to thermoplastically form the BMG material into the interlock surface features of the substrate. This could be done in a hot press or an autoclave, for example. It is also contemplated that the BMG material need not necessarily be required to be above the glass transition temperature during the initial stages of depositing. For example, in cold spraying the BMG material onto the substrate, the energy associated with accelerating particles of the BMG material to the substrate may be transformed into heat upon impact (so the particles of BMG material are not above Tg until impact).

The method can include forming a pattern in the BMG material on a surface of the BMG material opposite the substrate. Forming a pattern can include forming pattern features on at least one of a nano-scale, micro-scale, or macro-scale. It is also contemplated that forming a pattern can include forming pattern features configured for at least one of: erosion resistance, hydrophobic properties, anti-icing properties, bug resistance, or aerodynamic drag reduction.

A cladding system includes a cladding joined to a substrate. The cladding includes a BMG material. The substrate includes interlock surface features. The BMG material interlocks with the interlock surface features of the substrate.

The interlock surface features can include receptacles in the substrate with BMG material therein. The receptacles can narrow in a direction going deeper within the substrate. It is also contemplated that the receptacles can widen in a direction going deeper within the substrate. The cladding can include a layer of the BMG material on the substrate that is less than or equal to 2.0 mm thick.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIGS. 1-4 are schematic cross-sectional side elevation views of four exemplary embodiments of substrates constructed in accordance with the present disclosure, showing four different respective interlock surface features;

FIGS. 5-8 are schematic cross-sectional side elevation views of the substrates of FIGS. 1-4, respectively, showing a Bulk Metallic Glass (BMG) material interlocking with the interlock surface features; and

FIG. 9 is a schematic cross-sectional side elevation view of the substrate and BMG material of FIG. 5, showing a pattern being formed in the BMG material on a surface opposite the substrate.

### DETAILED DESCRIPTION OF THE PREFERRED EMBODIMENTS

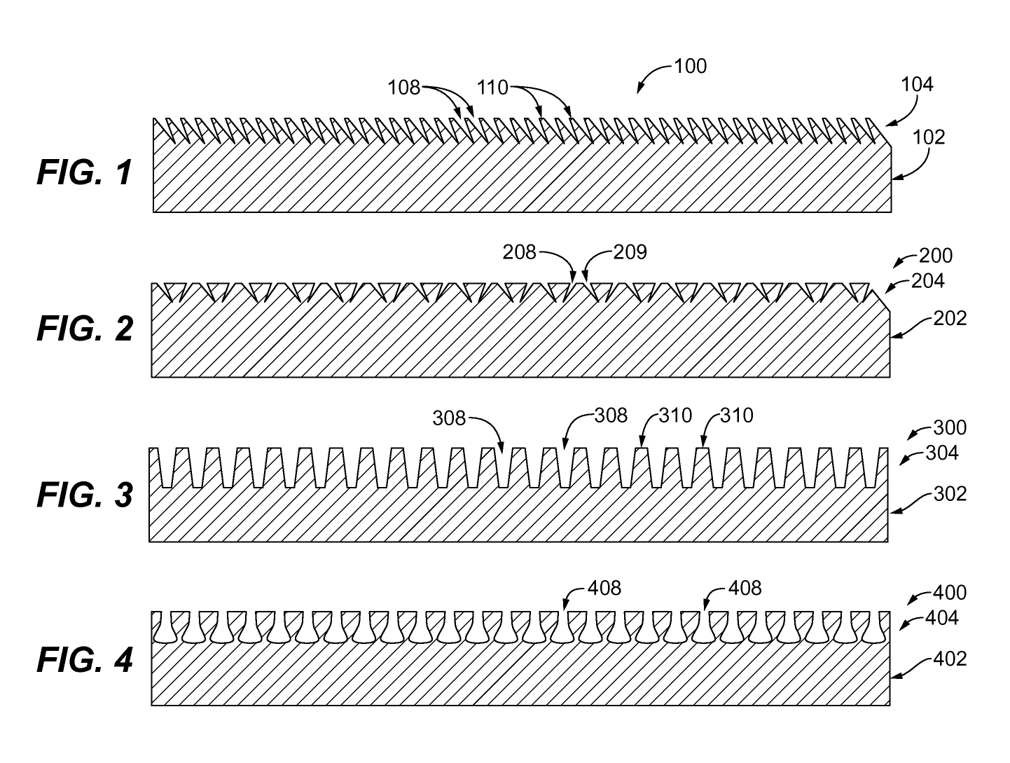

Reference will now be made to the drawings wherein like reference numerals identify similar structural features or aspects of the subject disclosure. For purposes of explanation and illustration, and not limitation, a partial view of an exemplary embodiment of a cladding system in accordance with the disclosure is shown in FIG. 1 and is designated generally by reference character 100. Other embodiments of cladding systems in accordance with the disclosure, or aspects thereof, are provided in FIGS. 2-9, as will be described. The systems and methods described herein can be used to provide surfaces with the advantageous properties of Bulk Metallic Glass (BMG) materials on structures with an underlying substrate of a non-BMG material.

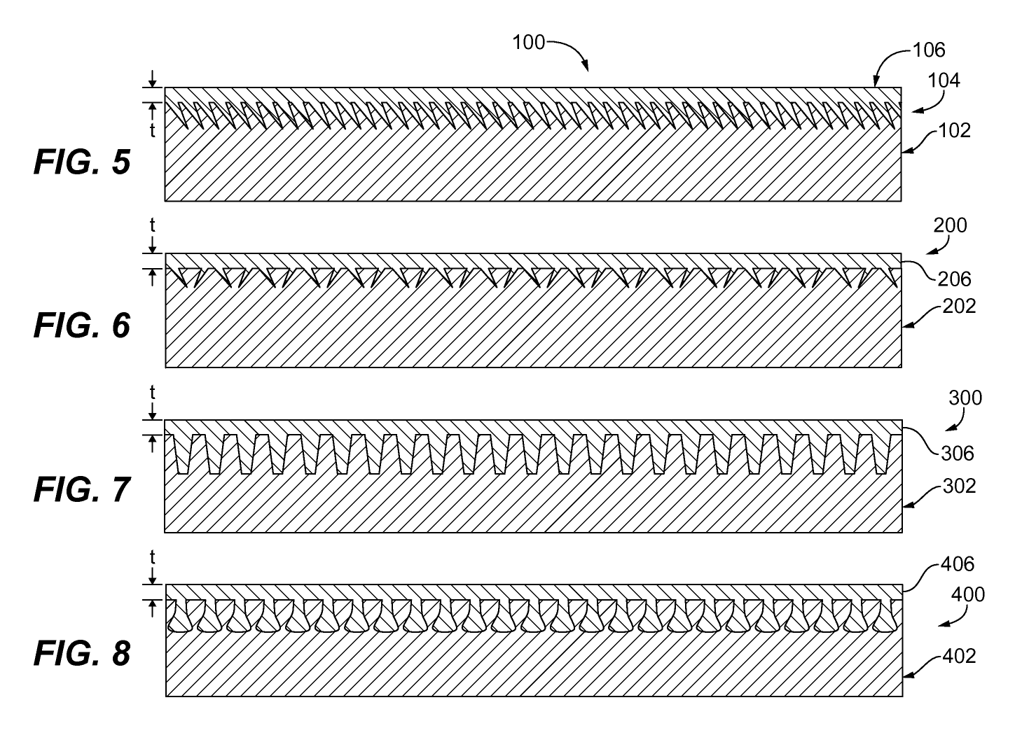

Cladding system 100 includes a substrate 102 a material such as a metal, glass, ceramic, polymer, composite, or any other suitable type of material. Substrate 102 is prepared for cladding with interlock surface features 104 on a surface thereof. A cladding 106 is joined to substrate 102. The cladding includes a BMG material. The BMG material interlocks with the interlock surface features 104 of the substrate, e.g., for a mechanical interlocking engagement. FIG. 1 shows substrate 102 prior to cladding 106 being joined thereto, and FIG. 5 shows cladding system 100 after substrate 102 and cladding 106 have been joined.

With continued reference to FIG. 1, interlock surface features 104 include receptacles 108 in the substrate with BMG material therein, e.g. receptacles 108 are the troughs between the peaks 110 of interlock surface features 104. For sake of clarity, not all of the peaks or receptacles are labeled in the Figures. Receptacles 108 narrow in a direction going deeper within the substrate 102. The interlock surface features 104 with receptacles for BMG material form a repeating pattern of substantially identical triangular receptacles 108. It is also contemplated that an alternating pattern of two sets of different triangular receptacles 208 and 209 can be used, such as in interlock surface features 204 of cladding system 200 of FIGS. 2 and 6, which includes a substrate 102 and cladding 106 much as described above with respect to FIGS. 1 and 5.

With reference to FIGS. 3 and 7, substrate 302 and cladding 306 of cladding system 300 are much as described above with respect to FIGS. 1 and 5. Interlock surface features 304 include receptacles that form a repeating pattern of substantially identical truncated triangular receptacles 308 with truncated triangular peeks or teeth 310 separating each respective adjacent pair of the receptacles 308.

Referring now to FIGS. 4 and 8, cladding system 400 has a substrate 402 that includes interlock surface features 404 with receptacles 408 that widen in a direction going deeper within the substrate 402. It is also contemplated that receptacles that have a uniform dimension going deeper within the substrate, e.g., that neither widen nor narrow, can be used, similar to the truncated triangle pattern in FIG. 3, but more rectangular. Cladding 406 is joined to substrate 402 much as described above with respect to FIGS. 1 and 5. Those skilled in the art will readily appreciate that any other suitable pattern can be used for the interlock surface features without departing from the scope of this disclosure.

The claddings 106, 206, 306, and 406 can include a layer of the BMG material on the substrate that is less than or equal to a typical thickness of 2.0 mm thick, but could be up to 10 mm thick or more, if the particular BMG material and deposition process permit. This thickness, t, is shown in FIGS. 5-8, and represents the thickness measured from the peaks of the interlock surface features 104, 204, 304, and 404, respectively, to the surface of claddings 106, 206, 306, and 406 that is opposite the respective substrates 102, 202, 302, and 402.

A method of forming a bulk metallic glass (BMG) cladding includes bringing a BMG material to a temperature lower than or equal to the crystallization temperature of the BMG material, and at least in some embodiments greater than or equal to the glass transition temperature of the BMG material and. For example, the BMG material can be placed in contact with the substrate with the BMG at room temperature and then the BMG can be heated up to the glass transition temperature (T_{g}) in order to thermoplastically form the BMG material into the interlock surface features of the substrate. This could be done in a hot press or an autoclave, for example. It is also contemplated that the BMG material need not necessarily be required to be above the glass transition temperature during the initial stages of depositing. For example, in cold spraying the BMG material onto the substrate, the energy associated with accelerating particles of the BMG material to the substrate may be transformed into heat upon impact (so the particles of BMG material are not above Tg until impact).

The method also includes depositing the BMG material onto a substrate, e.g., substrate 102, 202, 302, and 402, with interlock surface features, e.g., interlock surface features 104, 204, 304, and 404, such that the BMG material interlocks with the interlock surface features of the substrate. The method can include forming the interlock surface features on a surface of the substrate, e.g., prior to depositing the BMG material onto the substrate. In one example, anodic aluminum oxide structures can be formed on aluminum-bearing alloys to form interlock surface features with narrow, uniform tubule type structures. The interlock surface features can also be performed using chemical means or any other suitable technique. The interlock surface features can be formed of the same or different material than the substrate, and can be formed through any suitable methods such as chemical reaction(s), deposition/additive processes, and/or subtractive machining type operations. Those skilled in the art having the benefit of this disclosure will readily appreciate that the technique for forming the interlock surface features can be selected on an application by application basis to provide the desired BMG performance. For example, in the case of anodic aluminum oxide mentioned above, the oxide could provide the interlock features, but also may electrically and chemically isolate the substrate from the clad BMG material which could be important for corrosion applications.

It is also contemplated that the surface interlock features may already be present in a substrate, without a specific need to form them. For example, if a composite material is used for the substrate, a rough surface of a polymer matrix composite may provide sufficient repeating surface features to provide the interlock surface features used for interlocking with the BMG material.

Depositing the BMG material can include any suitable process such as at least one of thermoplastic forming, rolling, compression molding, autoclaving, cold spraying, thermal spraying, or hot pressing the BMG material onto the substrate such that the BMG material interlocks with the interlocking surface features of the substrate with the BMG material. Any other suitable deposition process or combination of processes can be used. For example, if a sheet of stock BMG is used, it can be brought to within the temperature range described above, and can then be rolled, compression molded, hot pressed, vacuum formed, autoclaved, or formed using any suitable plastic forming process, onto the substrate so that the BMG material flows into and interlocks with the interlock surface features mechanically. It is also contemplated that the BMG can be cold sprayed or thermal sprayed onto the substrate such that the BMG material interlocks with the interlocking surface features, e.g., wherein the BMG material is delivered to the substrate with the BMG material within the temperature range described above. It is also contemplated that the initial stage of depositing does not actually include flowing BMG material into the interlocking features, which flowing may occur after the initial deposition. For example, BMG material can be deposited onto a substrate up to a desired thickness via a process like cold spray, and subsequently the BMG material could be heated and rolled to provide the flowing into the interlock surface features.

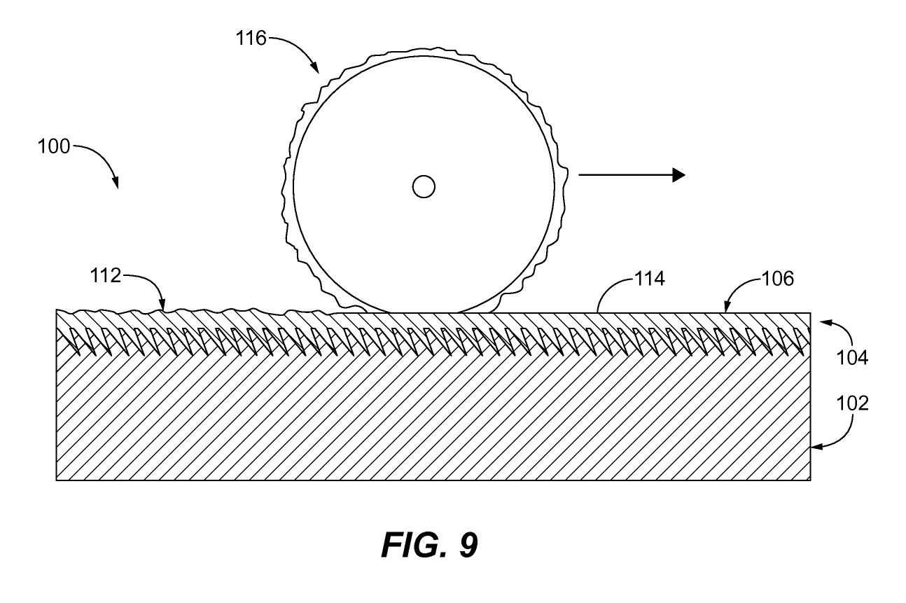

With reference now to FIG. 9, the method can include forming a pattern 112 in the BMG material on a surface 114 of the BMG material opposite the substrate 102, e.g. using pattern roller 116 rolling over the BMG material, while the BMG material is in the temperature range described above. It is possible to pattern the BMG material and join the BMG material to the substrate with the same rolling process. It is also contemplated that any other suitable process can be used to join the BMG material to the substrate, followed by patterning with a pattern roller. Additional details about pattern rollers can be found in International Patent Application Publication No. WO 2014/200700, which is incorporated by reference herein in its entirety. If the BMG material cools to a temperature below the glass transition temperature (T_{g}) after joining to the substrate but before surface patterning, the BMG material should be brought back to a temperature above the glass transition temperature (T_{g}) and below the crystallization temperature (Tₓ) for surface patterning. It is also contemplated that any other suitable process can be used to form a pattern in the surface of the BMG material.

Surface patterns can be formed on the substrate, e.g., by grit blasting, machining, laser surface patterning, EDM, chemical etching, or any other suitable process. In another example, allowing the BMG material to flow into a predefined pattern on the substrate can lead to a textured BMG surface, eliminating a need for rolling the BMG surface, or the like, to create a patterned surface.

Forming the pattern can include forming pattern features on at least one of a nano-scale, micro-scale, or macro-scale. It is also contemplated that forming a pattern can include forming pattern features configured for at least one of: erosion resistance, hydrophobic properties, anti-icing properties, bug resistance, aerodynamic drag reduction, or any other suitable properties.

BMG clad layers have the potential to replace traditional aerostructure titanium and aluminum components on airfoils such as leading edges for fan blades and nacelles. Those skilled in the art will readily appreciate that BMG clad layers as described herein can be used in any other suitable application without departing from the scope of this disclosure. BMG clad layers can offer significant benefits in terms of corrosion resistance, elastic storage modulus and ease of forming complex shapes. For example, direct replacement of titanium with a material that can be processed like a polymer, but has properties significantly better than most metallic engineering alloys, would offer a significant cost savings in manufacturing and machining of complex geometries.

The methods and systems of the present disclosure, as described above and shown in the drawings, provide for components with superior properties including surfaces with the advantageous properties of Bulk Metallic Glass (BMG) materials on structures having an underlying substrate of a non-BMG material. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A method of forming a bulk metallic glass (BMG) cladding comprising:
bringing a BMG material to a temperature lower than or equal to the crystallization temperature of the BMG material; and
depositing the BMG material onto a substrate with interlock surface features such that the BMG material interlocks with the interlock surface features of the substrate.

2. The method as recited in claim 1, further comprising forming the interlock surface features on a surface of the substrate.

3. The method as recited in claim 2, wherein forming the interlock surface features includes forming interlock surface features with receptacles for BMG material that narrow in a direction going deeper within the substrate.

4. The method as recited in claim 3, wherein forming the interlock surface features includes forming interlock surface features with receptacles for BMG material that form a repeating pattern of substantially identical triangular receptacles.

5. The method as recited in claim 3, wherein forming the interlock surface features includes forming interlock surface features with receptacles for BMG material that form an alternating pattern of two sets of different triangular receptacles.

6. The method as recited in claim 3, wherein forming the interlock surface features includes forming interlock surface features with receptacles for BMG material that form a repeating pattern of substantially identical truncated triangular receptacles with truncated triangular teeth separating each respective adjacent pair of the receptacles.

7. The method as recited in claim 2, wherein forming the interlock surface features includes forming interlock surface features with receptacles for BMG material that widen in a direction going deeper within the substrate.

8. The method as recited in claim 2, wherein depositing the BMG material includes at least one of thermoplastic forming, rolling, compression molding, hot pressing, autoclaving, thermal spraying, or cold spraying the BMG material onto the substrate such that the BMG material interlocks with the interlocking surface features of the substrate.

9. The method as recited in claim 1, further comprising forming a pattern in the BMG material on a surface of the BMG material opposite the substrate.

10. The method as recited in claim 9, wherein forming a pattern includes forming pattern features on at least one of a nano-scale, micro-scale, or macro-scale.

11. The method as recited in claim 9, wherein forming a pattern includes forming pattern features configured for at least one of: erosion resistance, hydrophobic properties, anti-icing properties, bug resistance, or aerodynamic drag reduction.

12. The method as recited in claim 1, wherein bringing the BMG material to a temperature lower than or equal to the crystallization temperature of the BMG material includes bringing a BMG material to a temperature greater than or equal to the glass transition temperature of the BMG material and lower than or equal to the crystallization temperature of the BMG material.

13. A cladding system comprising:
a cladding joined to a substrate, wherein the cladding includes a BMG material, wherein the substrate includes interlock surface features, and wherein the BMG material interlocks with the interlock surface features of the substrate.

14. The system as recited in claim 13, wherein the interlock surface features include receptacles in the substrate with BMG material therein, wherein the receptacles narrow in a direction going deeper within the substrate.

15. The system as recited in claim 13, wherein the interlock surface features include receptacles in the substrate with BMG material therein, wherein the receptacles widen in a direction going deeper within the substrate.

16. The system as recited in claim 13, wherein the BMG material includes a pattern defined therein on a surface of the BMG material opposite the substrate, wherein the pattern includes pattern features on at least one of a nano-scale, micro-scale, or macro-scale, and wherein the pattern includes pattern features configured for at least one of: erosion resistance, hydrophobic properties, anti-icing properties, bug resistance, or aerodynamic drag reduction.

17. The system as recited in claim 13, wherein the cladding includes a layer of the BMG material on the substrate that is less than or equal to 2.0 mm thick.

18. The system as recited in claim 13, wherein the interlock surface features include receptacles in the substrate with BMG material therein, wherein the receptacles have a uniform dimension in a direction going deeper within the substrate.
